(19) United States
(12) Patent Application Publication
(10) Pub. No.: US 2024/0408985 A1
(43) Pub. Date: Dec. 12, 2024

(54) APPARATUS AND METHOD FOR OPTIMIZING SCHEDULING, AVAILABILITY AND UTILIZATION OF ENERGY DISPENSERS FOR NON-HYDROCARBON FUELED VEHICLES

(71) Applicant: ZEV STATION HOLDING, LLC, Chandler, AZ (US)

(72) Inventors: Jesse SCHNEIDER, Chandler, AZ (US); Jonathan O'HARE, East Greenwich, RI (US)

(21) Appl. No.: 18/691,735

(22) PCT Filed: Sep. 13, 2022
(86) PCT No.: PCT/US2022/043321

§ 371 Date: Mar. 13, 2024

Related U.S. Application Data
(60) Provisional application No. 63/243,253, filed on Sep. 13, 2021.

(51) Int. Cl. B60L 53/30; B60L 53/60; G06T 11/20

(52) U.S. Cl. CPC B60L 53/305; B60L 53/60; G06T 11/206

(57) ABSTRACT

An apparatus for energy replenishment, fueling for non-hydrocarbon fueled vehicles includes a reconfigurable display comprising a matrix graphically representing and communicating locations and energy type or refueling status of a plurality of energy dispensers for non-hydrocarbon fueled vehicles. A method of scheduling availability of a plurality of energy dispensers in a refueling station forecourt for non-hydrocarbon fueled vehicles includes providing the reconfigurable display to help vehicle operators choose a location that improves traffic flow and reduce congestion within the forecourt. The reconfigurable display may indicate that a first energy dispenser in the plurality of energy dispensers is unavailable until a second energy dispenser in the plurality of energy dispensers immediately forward of the first energy dispenser is occupied.

### CROSS-REFERENCE TO RELATED APPLICATION

This application claims benefit of priority under Article 8 of the Patent Cooperation Treaty to U.S. Provisional Patent Application No. 63/243,253 filed on Sep. 13, 2021, the entire disclosure of which is hereby incorporated by reference.

### TECHNICAL FIELD OF THE INVENTION

The invention generally relates to an apparatus and method for optimizing scheduling, communicating, data gathering availability and utilization of energy dispensers for non-hydrocarbon fueled vehicles, e.g., hydrogen internal combustion, hydrogen fuel cell, battery electric vehicles, and other zero emission vehicles.

### BACKGROUND

The energy replenishment of non-hydrocarbon fueled vehicles typically requires more time than the equivalent energy replenishment time of hydrocarbon fueled vehicles, for instance with electric charging. Additionally, hydrocarbon petroleum fueled vehicles generally have more distance per fueling then non-hydrocarbon fueled vehicles and do not have to refill as often. Therefore, it may be desirable to minimize the wait time for vehicles at an energy replenishment station having multiple energy dispensers prior to energy replenishment. Further, in energy replenishment stations providing energy in multiple incompatible forms, it may be desirable to direct a vehicle to a compatible energy dispenser.

### SUMMARY

According to one or more aspects of the present disclosure, an apparatus for energy replenishment for non-hydrocarbon fueled vehicles includes a reconfigurable display comprising a matrix graphically representing locations and energy type or refueling status of a plurality of energy dispensers for non-hydrocarbon fueled vehicles.

In one or more embodiments of the apparatus according to the previous paragraph, the energy type is electric, and the plurality of energy dispensers provide electrical power.

In one or more embodiments of the apparatus according to any one of the previous paragraphs, the matrix displays an indication of an electrical power level available from the plurality of energy dispensers. The power level could be maximum power available or a rated power level available.

In one or more embodiments of the apparatus according to any one of the previous paragraphs, an electrical power level available is displayed in watts.

In one or more embodiments of the apparatus according to any one of the previous paragraphs, the energy type is hydrogen, and the plurality of energy dispensers provide hydrogen in a form selected from a list consisting of liquid hydrogen (LH2), compressed hydrogen (ch2), and cryocompressed hydrogen (CcH2).

In one or more embodiments of the apparatus according to any one of the previous paragraphs, the matrix displays an indication of the form of hydrogen.

In one or more embodiments of the apparatus according to any one of the previous paragraphs, the matrix displays an indication of an available pressure rating of compressed hydrogen.

In one or more embodiments of the apparatus according to any one of the previous paragraphs, the available or maximum pressure rating of compressed hydrogen is displayed in English or SI units of pressure.

In one or more embodiments of the apparatus according to any one of the previous paragraphs, the matrix displays a remaining time for of an energy storage device connected to one of the plurality of energy dispensers to reach a desired energy capacity.

In one or more embodiments of the apparatus according to any one of the previous paragraphs, the matrix displays the remaining time as a pie chart.

In one or more embodiments of the apparatus according to any one of the previous paragraphs, the matrix displays the remaining time as a bar chart.

In one or more embodiments of the apparatus according to any one of the previous paragraphs, the matrix displays a series of changing shapes indicating the remaining time.

In one or more embodiments of the apparatus according to any one of the previous paragraphs, the matrix displays an alphanumeric value indicating the remaining time.

In one or more embodiments of the apparatus according to any one of the previous paragraphs, the matrix displays a symbol or alphanumeric message when one of the plurality of energy dispensers is not in use.

In one or more embodiments of the apparatus according to any one of the previous paragraphs, the matrix displays a symbol or alphanumeric message when one of the plurality of energy dispensers is not in service.

In one or more embodiments of the apparatus according to any one of the previous paragraphs, the matrix graphically or alphanumerically displays a timer or countdown timer indicating a delay time before delivery of energy from one of the plurality of energy dispensers may commence.

In one or more embodiments of the apparatus according to any one of the previous paragraphs, the matrix is displayed on a portable personal electronic device.

According to one or more aspects of the present disclosure, a method of scheduling availability of a plurality of energy dispensers in a refueling station forecourt for non-hydrocarbon fueled vehicles includes providing a reconfigurable display comprising a matrix graphically representing locations and energy type or refueling status of a plurality of energy dispensers, thereby helping vehicle operators choose a location that improves or optimizes traffic flow and reduce congestion within the forecourt.

In one or more embodiments of the method according to the previous paragraph, the method further includes indicating an electrical power level available from the plurality of energy dispensers when the energy type is electric, and the plurality of energy dispensers provide electrical power.

In one or more embodiments of the method according to any one of the previous paragraphs, the method further includes indicating an electrical power level available displayed in watts.

In one or more embodiments of the method according to any one of the previous paragraphs, the method further includes indicating a form of hydrogen selected from a list consisting of liquid hydrogen and compressed hydrogen when the energy type is hydrogen, and the plurality of energy dispensers provide hydrogen.

In one or more embodiments of the method according to any one of the previous paragraphs, the method further includes indicating a form of hydrogen selected from a list consisting of liquid hydrogen and compressed hydrogen when the energy type is hydrogen, and the plurality of energy dispensers provide hydrogen.

In one or more embodiments of the method according to any one of the previous paragraphs, the method further includes indicating an available pressure rating of compressed hydrogen.

In one or more embodiments of the method according to any one of the previous paragraphs, the method further includes indicating a remaining time for of an energy storage device connected to one of the plurality of energy dispensers to reach a desired energy capacity.

In one or more embodiments of the method according to any one of the previous paragraphs, the method further includes indicating the remaining time as a pie chart.

In one or more embodiments of the method according to any one of the previous paragraphs, the method further includes indicating the remaining time as a bar chart.

In one or more embodiments of the method according to any one of the previous paragraphs, the method further includes displaying a series of changing shapes indicating the remaining time.

In one or more embodiments of the method according to any one of the previous paragraphs, the method further includes indicating the remaining time.

In one or more embodiments of the method according to any one of the previous paragraphs, the method further displaying a symbol or alphanumeric message when one of the plurality of energy dispensers is not in use.

In one or more embodiments of the method according to any one of the previous paragraphs, the method further includes displaying a symbol or alphanumeric message when one of the plurality of energy dispensers is not in service.

In one or more embodiments of the method according to any one of the previous paragraphs, the method further includes providing an audible indication when one of the plurality of energy dispensers is not in service.

In one or more embodiments of the method according to any one of the previous paragraphs, the method further includes indicating a delay time before delivery of energy from one of the plurality of energy dispensers may commence.

According to one or more aspects of the present disclosure, a method of scheduling availability of a plurality of energy dispensers in a refueling station forecourt for non-hydrocarbon fueled vehicles includes providing a reconfigurable display comprising a matrix graphically representing locations availability status of a plurality of energy dispensers and indicating that a first energy dispenser in the plurality of energy dispensers is unavailable until a second energy dispenser in the plurality of energy dispensers immediately forward of the first energy dispenser is occupied.

### BRIEF DESCRIPTION OF THE DRAWINGS

The present invention will now be described, by way of example with reference to the accompanying drawings, in which:

FIG. 1 is a perspective view an electrical energy replenishment station having a plurality of energy dispensers according to some embodiments;

FIG. 2 is top schematic view of the electrical energy replenishment station of FIG. 1 according to some embodiments;

FIG. 3 is a chart of status indicators of the electrical energy replenishment station of FIG. 1 according to some embodiments;

FIG. 4 is a perspective view a hydrogen energy replenishment station having a plurality of energy dispensers according to some embodiments;

FIG. 5 is top schematic view of the hydrogen energy replenishment station of FIG. 4 according to some embodiments; and

FIG. 6 is a chart of status indicators of the hydrogen energy replenishment station of FIG. 4 according to some embodiments.

### DETAILED DESCRIPTION

This patent application describes an apparatus and a method for optimizing the scheduling, availability and utilization of energy dispensers for non-hydrocarbon fueled vehicles as electrical or hydrogen powered automobiles, heavy trucks, rail vehicles, marine vehicles, logistic, and aerospace vehicles. Additionally, the described system will optimize vehicle flow, avoid excessive queuing and maximize the number of vehicles being serviced in a given time frame to maximize the revenue of a fueling station.

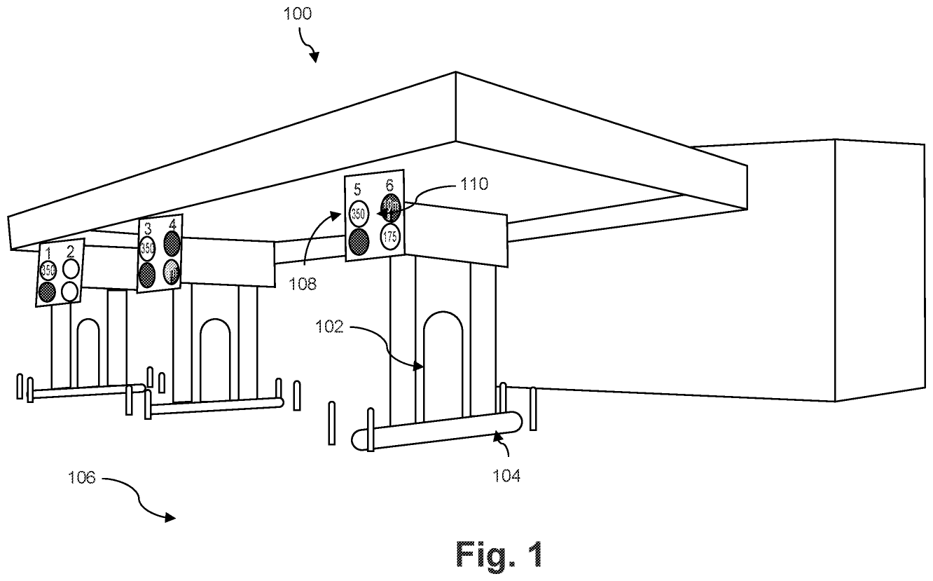

FIG. 1 illustrates an example of an electrical energy replenishment station 100, e.g., for battery electric vehicles. The layout is similar to typical gasoline refueling plazas with a plurality of energy dispensers (charging stations 102), placed on islands 104 in a large lot 106 with vehicle lanes running between the islands. In this example, the charging stations are capable of providing electrical power at different power levels during the charging cycle. Therefore, it is advantageous to indicate to vehicle drivers which power levels are available so that they may choose the highest power level compatible with their vehicle to optimize charging time. As shown in FIG. 1, each of the islands has a reconfigurable display 108 including a matrix 110 graphically representing the relative locations, power levels, and recharging status of each charging station on the island. The reconfigurable display is in communication with an electronic controller that controls the information shown on the display based on data received from the charging stations and the vehicles. The controller may be in communication with the charging stations via a wired or wireless data link. The controller may also be in communication with the vehicles via a data link between the vehicle and the charging station or a direct data link via wireless data communication such as Institute of Electrical and Electronics Engineers (IEEE) 802.11 and/or Society of Automotive Engineers (SAE) J2753/J2799/J2945/J3161 Vehicle to Infrastructure (V2I) communication.

The charging stations may provide alternating current charging (AC), direct current charging (DC), and wireless power transfer (WPT) or wireless charging and conform to one or more charging specifications, such as SAE J1772, SAE J2954, CHAdeMo, Combined Charging system (CCS), or TESLA Supercharger.

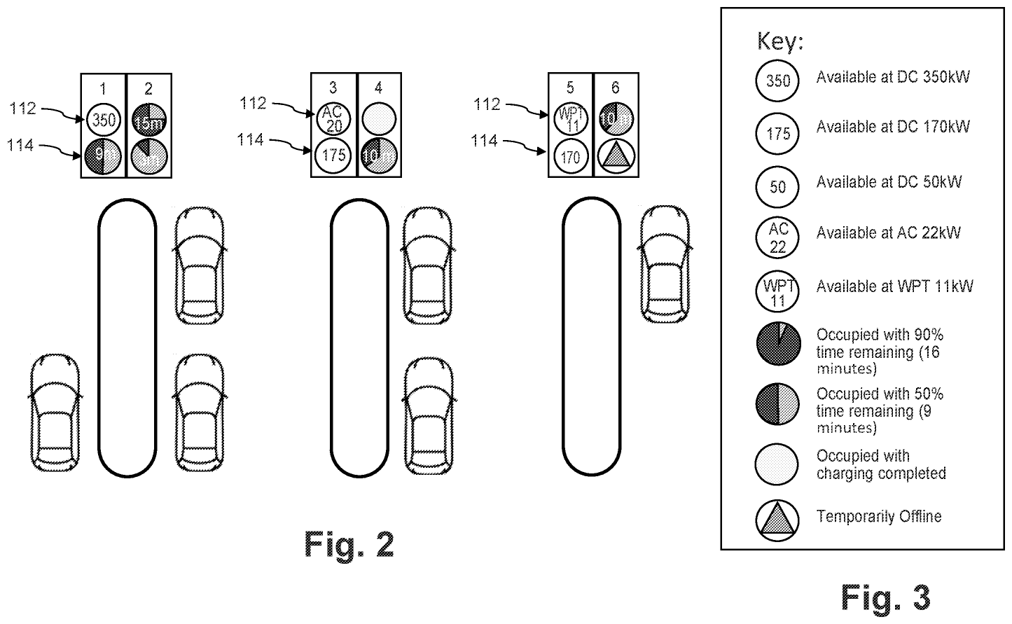

As shown in FIG. 2, the matrix will indicate the power level available 112 when the charging station is unoccupied by a vehicle, e.g., 50, 175, or 350 kilowatts. The vehicle proximity of the vehicle to the charging station may be detected by a magnetic sensor or an optical sensor, e.g., a camera.

When a vehicle is detected at the charging station or is connected to the charging station, the matrix will show the charging status 114 of energy storage device, e.g., battery, in the vehicle by indicating the time remaining to reach a desired capacity in the storage device or if the desired capacity has been reached. The desired capacity may not be the full capacity, since it may take less time to go from 20% to 80% capacity than to go from 80% to 100% capacity. Displaying the time remaining is useful to both a person recharging the vehicle so that they know how long before they can resume their journey and to a person waiting to use a charging station so that they can get in a traffic lane for the properly powered charging station with the least remaining charging time. The remaining time may be indicated alphanumerically or graphically using changing pie or bar graphs, changing symbols, or changing colors as shown in FIG. 3. The matrix may also indicate a time remaining before an unoccupied charging station will be ready to accept another vehicle. The reconfigurable display may include a light emitting diode (LED) display, flip cards, or any other suitable display technology.

Alternatively, or in addition, to providing the reconfigurable display on the island, the matrix may be displayed on a personal electronic device, such as a smartphone or smartwatch running a dedicated software application.

By indicating the available power levels and charge time remaining at each charging station, the traffic flow can be better managed or optimized by either a vehicle driver, an automated vehicle, or an autonomous vehicle in wireless communication with the controller via IEEE 802.11 or V2I communication.

When an autonomous vehicle is detected at the charging station, an attendant of the electrical energy replenishment station could be signaled to manually connect the vehicle to the charging station and then signaled again to manually disconnect the vehicle from the charging station when the desired capacity is attained. Alternatively, the charging station may include an apparatus to automatically connect and disconnect the autonomous vehicle to the charging station (e.g., robotic arm). The autonomous vehicle may be detected via a sensor, such as a camera, metal detector, weight sensor, sound sensor, and other like sensing systems. The attendant or robotic arm can be signaled both when connection is needed and also when disconnection is needed. The autonomous vehicle may communicate with the sensors, fueling station, attendant or robotic system via Bluetooth, cellular network, wireless internet network, etc. The autonomous vehicle may be directed to the shortest queue or directed to a different queue once in line dependent on the factors discussed and subsequent communication and indication of the system. Traffic flow would then be optimized to reduce fueling times and maximize the number of vehicles being serviced to increase the revenue of the fueling station.

The matrix may also indicate when a charging station is out-of-service. In addition to this visual indication, an audible indication may also be presented to the person at the out-of-service charging station from an annunciator on the island or an audio alert produced by the smartphone or smartwatch running the dedicated software application.

In case of a loss of external electrical power, the entire electrical energy replenishment station may be on battery backup, especially at night, with no wind or solar backup power available. The electrical energy replenishment station may then reduce electrical power supplied by the charging stations e.g., from 350 kilowatts to 50 kilowatts while the electrical energy replenishment station is on battery backup. This would be indicated on the reconfigurable display and the reconfigurable display may also indicate when the external power is restored, and electrical power output levels of the charging stations return to normal.

In other embodiments, the reconfigurable display may be located remotely from the island, e.g., between an entrance to the energy replenishment station and a forecourt between the entrance and the charging stations.

In yet another embodiment, the reconfigurable display may indicate that a first charging station is in an out-of-service or unavailable status until a second charging station located on the island immediately forward of the first charging station is occupied.

In yet other embodiments, the charging stations may be placed in a geometric array and the reconfigurable display may be placed in a central location, e.g., on an airport tarmac. In addition, the charging stations may be components of a microgrid.

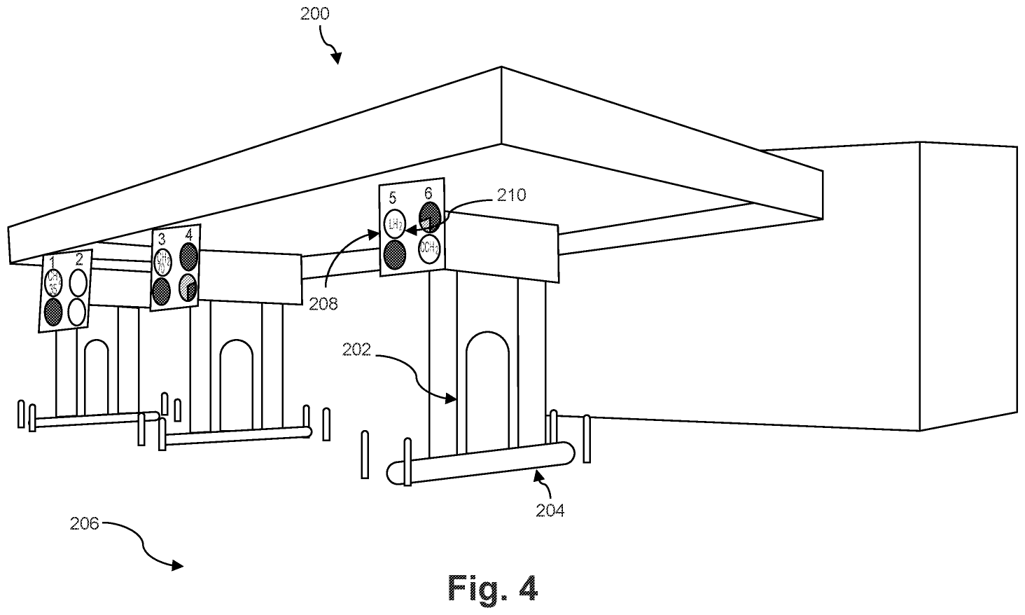

FIG. 4 illustrates another example of a hydrogen energy replenishment station 200, e.g., for hydrogen powered internal combustion of fuel cell vehicles. The layout is similar to the electrical energy replenishment station 100 described above with a plurality of energy dispensers (hydrogen pumps 202), placed on islands 204 in a large lot 206 with vehicle lanes running between the islands. In this example, the hydrogen pumps are capable of providing either liquid hydrogen, compressed hydrogen at different pressures, or cryocompressed hydrogen. Therefore, it is advantageous to indicate to vehicle drivers which form of hydrogen is available so that they can chose the hydrogen pump compatible with their vehicle. As shown in FIG. 4, each of the islands has a reconfigurable display 208 including a matrix 210 graphically representing the relative locations, hydrogen type, and refueling status of each hydrogen pump on the island. The reconfigurable display is in communication with an electronic controller that controls the information shown on the display based on data received from the charging stations and the vehicles. The controller may be in communication with the charging stations via a wired or wireless data link. The controller may also be in communication with the vehicles via a data link between the vehicle and the charging station or a direct data link via wireless data communication such as Institute of IEEE 802.11 and/or Society of Automotive Engineers (SAE) J2753/J2945/J3161 V2I communication.

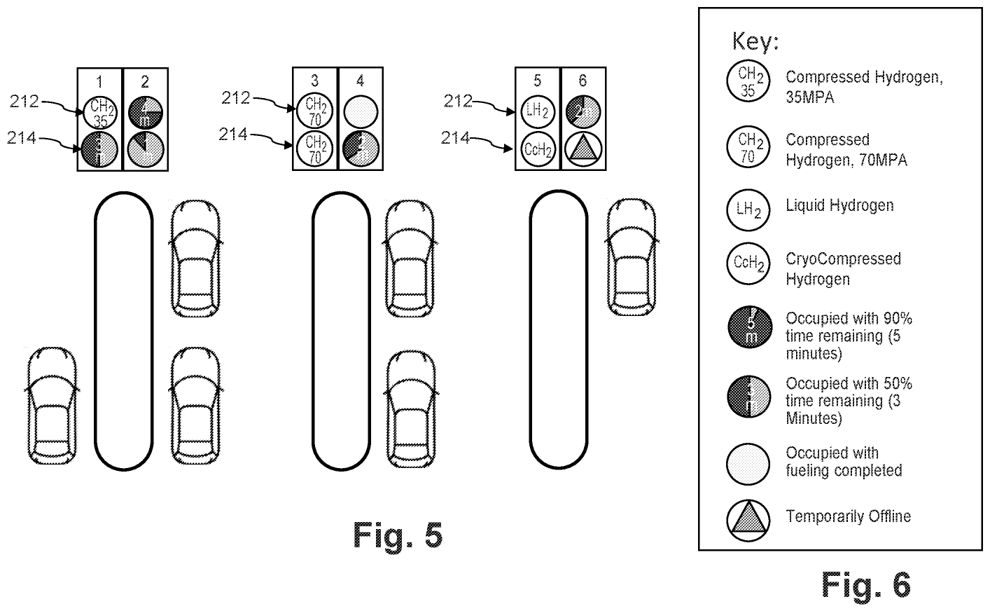

As shown in FIG. 5, the matrix will indicate the hydrogen type and pressure 212 (if applicable) available when the charging station is unoccupied by a vehicle, e.g., 35 MPa compressed hydrogen, 70 MPa compressed hydrogen, liquid hydrogen, or cryocompressed hydrogen. The vehicle proximity of the vehicle to the hydrogen pump may be detected by a magnetic sensor or an optical sensor, e.g., a camera.

When a vehicle is detected at the hydrogen pump or is connected to the hydrogen pump, the matrix will show the filling status 214 of an energy storage device, e.g., hydrogen tank, in the vehicle by indicating the time remaining to reach a desired capacity in the storage device or if the desired capacity has been reached. The desired capacity may not be the full capacity, since it may take less time to go from 20% to 80% capacity than to go from 80% to 100% capacity. Displaying the time remaining is useful to both a person refueling the vehicle so that they know how long before they can resume their journey and to a person waiting to use a hydrogen pump so that they can get into a traffic lane for the proper hydrogen pump for their vehicle with the least remaining refueling time. The remaining time may be indicated alphanumerically or graphically using changing pie or bar graphs, changing symbols, or changing colors as shown in FIG. 6. The matrix may also indicate a time remaining before an unoccupied hydrogen pump will be ready to accept another vehicle. The reconfigurable display may include a light emitting diode (LED) display, flip cards, or any other suitable display technology.

Alternatively, or in addition, to providing the reconfigurable display on the island, the matrix may be displayed on a personal electronic device, such as a smartphone or smartwatch running a dedicated software application.

The matrix may also indicate when a hydrogen pump is out-of-service. In addition to this visual indication, an audible indication may also be presented to the person at the out-of-service hydrogen pump from an annunciator on the island or an audio alert produced by the smartphone or smartwatch running the dedicated software application.

By indicating the available hydrogen types and fill time remaining at each hydrogen pump, the traffic flow can be better managed or optimized by either a vehicle driver, an automated vehicle, or an autonomous vehicle in wireless communication with the controller via IEEE 802.11 or V2I communication.

When an autonomous vehicle is detected at the hydrogen pump, an attendant of the hydrogen energy replenishment station could be signaled to manually connect the vehicle to the hydrogen pump and then signaled again to manually disconnect the vehicle from the charging station when the desired capacity is attained. Alternatively, the hydrogen pump may include an apparatus to automatically connect and disconnect the autonomous vehicle to the hydrogen pump.

The hydrogen pumps may conform to one or more specifications, such as SAE J2601 (Hydrogen Fueling Protocols), SAE J2799 (Wireless Vehicle to Station Communications for Hydrogen Fueling), ISO 19880-1, Gaseous Hydrogen Fueling Stations, and/or ISO 19885 (Heavy Duty Hydrogen Fueling).

Communications can be sent through a metal detector and confirmation from the vehicle to the system that an employee of the station has to go out and connect the hydrogen pump to the vehicle.

In case of a loss of external electrical power, the entire hydrogen energy replenishment station may be on battery backup, especially at night, with no wind or solar backup power available. The hydrogen energy replenishment station may then reduce the pressure of hydrogen supplied by the hydrogen pumps while the hydrogen energy replenishment station is on battery backup. This would be indicated on the reconfigurable display and the reconfigurable display may also indicate when the external power is restored, and pressure levels of the hydrogen pumps return to normal.

In other embodiments, the reconfigurable display may be located remotely from the island, e.g., between an entrance to the energy replenishment station and a forecourt between the entrance and the hydrogen pumps.

In yet another embodiment, the reconfigurable display may indicate that a first charging station is in an out-of-service or unavailable status until a second charging station located on the island immediately forward of the first charging station is occupied. While this embodiment directed to energy dispensers for non-hydrocarbon fueled vehicles, aspects of this embodiment may be applied to filling stations for hydrocarbon powered vehicles.

In yet other embodiments, the hydrogen pumps may be placed in a geometric array and the reconfigurable display may be placed in a central location, e.g., on an airport tarmac for a system used to fuel aircraft.

In yet other embodiments, the reconfigurable display may be mirrored, i.e., duplicated, in the vehicle on the vehicle's infotainment display, driving information display, control display, or any other display built into the vehicle that is capable of mirroring the reconfigurable display of the electrical/hydrogen energy replenishment station. Alternatively, the reconfigurable display may be mirrored in the vehicle on a personal electronic device, such as a smartphone, tablet computer, or laptop computer. The data required to mirror the reconfigurable display may be transmitted to the vehicle via any of the known wireless data transmission protocols, including, but not limited to, WI-FI, BLUETOOTH, cellular telephone, Near Field Communication (NFC), vehicle to infrastructure (V2X), or satellite, e.g., IRIDIUM, GLOBALSTAR, STAR LINK, protocols. A return data path from the vehicle to the electrical/hydrogen energy replenishment station is preferably provided by the wireless data link.

In yet other embodiments, charging and fueling location information, including, but not limited to, electrical/hydrogen energy replenishment station location, operating hours, current fueling/charging availability, and fueling/charging reservations may be transmitted between the electrical/hydrogen energy replenishment station and a remote vehicle hundreds of meters to hundreds of miles away from the electrical/hydrogen energy replenishment station. The data required may be transmitted to the vehicle via any of the known wireless data transmission protocols, including, but not limited to, WI-FI, BLUETOOTH, cellular telephone, vehicle to infrastructure (V2X), or satellite protocols. A return data path from the vehicle to the electrical/hydrogen energy replenishment station is preferably provided by the wireless data link.

While the illustrated embodiments show a traditional fueling plaza, the fueling system and the methods of operating the fueling system described herein may be situated in other locations and layouts, such as being integrated into a parking lot or a parking structure.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An apparatus for energy replenishment or fueling for non-hydrocarbon fueled vehicles, comprising:
a reconfigurable display comprising a matrix graphically representing and communicating locations and energy type or refueling status of a plurality of energy dispensers for non-hydrocarbon fueled vehicles.

2. The apparatus according to claim 1, wherein the energy type is electric, and the plurality of energy dispensers provide electrical power.

3. The apparatus according to claim 2, wherein the matrix displays an indication of an electrical power level available from the plurality of energy dispensers.

4. (canceled)

5. The apparatus according to claim 1, wherein the energy type is hydrogen, and the plurality of energy dispensers provide hydrogen in a form selected from a list consisting of liquid hydrogen and compressed hydrogen.

6. The apparatus according to claim 5, wherein the matrix displays an indication of the form of hydrogen.

7. The apparatus according to claim 5, wherein the matrix displays an indication of an available pressure rating of compressed hydrogen.

8. (canceled)

9. The apparatus according to claim 1, wherein the matrix displays a remaining time for of an energy storage device connected to one of the plurality of energy dispensers to reach a desired energy capacity.

10.-11. (canceled)

12. The apparatus according to claim 9, wherein the matrix displays a series of changing shapes indicating the remaining time.

13.-15. (canceled)

16. The apparatus according to claim 1, wherein the matrix graphically or alphanumerically displays a timer or countdown timer indicating a delay time before delivery of energy from one of the plurality of energy dispensers may commence.

17. The apparatus according to claim 1, wherein the matrix is displayed on a portable personal electronic device.

18. A method of scheduling availability of a plurality of energy dispensers in a refueling station forecourt for non-hydrocarbon fueled vehicles, comprising:
providing a reconfigurable display comprising a matrix graphically representing locations and energy type or refueling status of a plurality of energy dispensers, thereby helping vehicle operators choose a location that improves traffic flow and reduce congestion within the forecourt.

19. The method according to claim 18, further comprising indicating an electrical power level available from the plurality of energy dispensers when the energy type is electric, and the plurality of energy dispensers provide electrical power.

20. The method according to claim 19, further comprising indicating an electrical power level available displayed in watts.

21. The method according to claim 18, further comprising indicating a form of hydrogen selected from a list consisting of liquid hydrogen and compressed hydrogen when the energy type is hydrogen, and the plurality of energy dispensers provide hydrogen.

22. The method according to claim 21, further comprising indicating an available pressure rating of compressed hydrogen.

23. The method according to claim 18, further comprising indicating a remaining time for of an energy storage device connected to one of the plurality of energy dispensers to reach a desired energy capacity.

24. The method according to claim 23, further comprising indicating the remaining time as a pie chart.

25.-27. (canceled)

28. The method according to claim 18, further comprising displaying a symbol or alphanumeric message when one of the plurality of energy dispensers is not in use.

29.-30. (canceled)

31. The method according to claim 18, further comprising indicating a delay time before delivery of energy from one of the plurality of energy dispensers may commence.

32. A method of scheduling availability of a plurality of energy dispensers in a refueling station forecourt for non-hydrocarbon fueled vehicles, comprising:
providing a reconfigurable display comprising a matrix graphically representing locations availability status of a plurality of energy dispensers; and
indicating that a first energy dispenser in the plurality of energy dispensers is unavailable until a second energy dispenser in the plurality of energy dispensers immediately forward of the first energy dispenser is occupied.

33. (canceled)
